(19) United States
(12) Patent Application Publication
(10) Pub. No.: US 2015/0262115 A1
(43) Pub. Date: Sep. 17, 2015

(54) INTERACTIVE ORDER FULFILLMENT SYSTEM

(71) Applicant: TOSHIBA GLOBAL COMMERCE SOLUTIONS HOLDINGS CORPORATION, Tokyo (JP)

(72) Inventors: Jon A. Meulenberg, Cary, NC (US); Monsak Jason Chirakansakcharoen, Raleigh, NC (US); Dean Frederick Herring, Youngsville, NC (US); Kenneth B. Hammer, Cary, NC (US)

(73) Assignee: TOSHIBA GLOBAL COMMERCE SOLUTIONS HOLDINGS CORPORATION, Tokyo (JP)

(21) Appl. No.: 14/205,298

(22) Filed: Mar. 11, 2014

(51) Int. Cl. G06Q 10/08; G06Q 30/00

(52) U.S. Cl. CPC G06Q 10/087; G06Q 30/00

(57) ABSTRACT

Embodiments disclose an interactive order fulfillment system, as well as a corresponding method and computer-readable storage medium, in which indications of order fulfillment status are displayed onto a surface of a receptacle used for fulfilling the order. The interactive order fulfillment system may operate as a virtual receipt with which an employee may interact to more efficiently fulfill the order.

### BACKGROUND

This disclosure relates generally to order fulfillment systems, and more particularly to an interactive order fulfillment system using order receptacles as interactive surfaces.

Many industries rely on accurate and efficient order fulfillment in their day-to-day operations, the industries ranging anywhere from small retail and food service establishments to massive supply and logistics centers having global distribution networks. Especially in those industries that are not highly automated, human employees are heavily, often entirely, relied upon to fulfill orders. Idiosyncrasies of individual employees, when combined with other human factors, such as boredom, stress, inattention, forgetfulness, etc. often lead to mistakes or inefficiency in the order fulfillment process.

### SUMMARY

One embodiment provides a method that includes displaying an indication of an order fulfillment status onto a surface of a receptacle. The receptacle is generally configured to receive one or more of the order items. The method further includes updating the order fulfillment status based on a detected interaction with the displayed indication.

Another embodiment provides an interactive order fulfillment system that includes a receptacle for receiving one or more items from the order, a display device configured to display an indication of an order fulfillment status onto a surface of the receptacle. The interactive order fulfillment system further includes an input device configured to detect interaction with the displayed indication, and a controller configured to update the order fulfillment status based on the detected interaction.

Yet another embodiment provides a computer-readable storage medium storing an application. When executed on a processor, the application performs an operation that includes displaying an indication of an order fulfillment status onto a surface of a receptacle, where the receptacle configured to receive one or more items included in the order. The operation further includes updating the order fulfillment status based on a detected interaction with the displayed indication.

### BRIEF DESCRIPTION OF THE SEVERAL VIEWS OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an interactive order fulfillment system, according to one embodiment described herein.

FIGS. 2A-2C depict an interactive surface in an interactive order fulfillment system, according to one embodiment described herein.

FIGS. 3A and 3B depict an interactive surface in an interactive order fulfillment system, according to one embodiment described herein.

FIGS. 4A and 4B depict an interactive surface in an interactive order fulfillment system, according to one embodiment described herein.

FIG. 5 depicts an example of an interactive order fulfillment system, according to one embodiment described herein.

FIG. 6 is a block diagram depicting a method for order fulfillment, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

Described in various embodiments of this disclosure is an interactive order fulfillment system, in which indications of order fulfillment status may be displayed onto a surface of a receptacle used for fulfilling the order; that is, the receptacle is used for holding one or more items from the order as the order is being fulfilled. Within certain industries, such as retail shopping or food service, the interactive order fulfillment system may operate as a virtual receipt with which an employee may interact to more efficiently fulfill the order.

The order fulfillment status may generally be represented using any feasible content, formatting, and layout; each of these may be selected to improve the presentability or readability of the displayed indication, to improve the efficiency of corresponding interactions with the displayed indication, and/or according to any number of additional criteria. The indications may include a partial or complete textual listing or graphical display of items included in the order, or a similar listing or display that selectively includes certain items or groups of items (such as order items that have not yet been fulfilled).

The interactive order fulfillment system may be networked with numerous other computing systems related to the order fulfillment process, such as systems controlling or monitoring inventory, item assembly or production, transportation, etc. Alternatively, the interactive order fulfillment system may natively include such functionality. By using data generated during the order fulfillment process (often provided by the networked systems), the interactive order fulfillment system may provide more effective indications of order fulfillment status. The indications may include status(es) of order items, estimate(s) of time remaining until fulfillment of particular items (or of the entire order), etc.

As mentioned above, indications of order fulfillment status may generally be presented in textual or graphical formats, or may include combinations thereof. For example, the indications may include color-coded indications reflecting a status of the collective order, or reflecting statuses of certain items or groupings of items. The color coding schemes may include colors reflecting discrete levels of fulfillment (such as green representing fulfilled items, yellow for partially fulfilled, and red for not fulfilled), or may include continuous color gradients reflecting some measure of fulfillment (such as a hot/cold gradient based on an estimated value, such as time remaining). Of course, differing graphical schemes may be selected for use at different levels. For example, individual items may be represented by discrete-level color indicators, and groups of those items may use a single color indicator corresponding to an average value of the component items' color indicators, or may display each of the component items' color indicators in a matrix, or using any other suitable graphical display techniques.

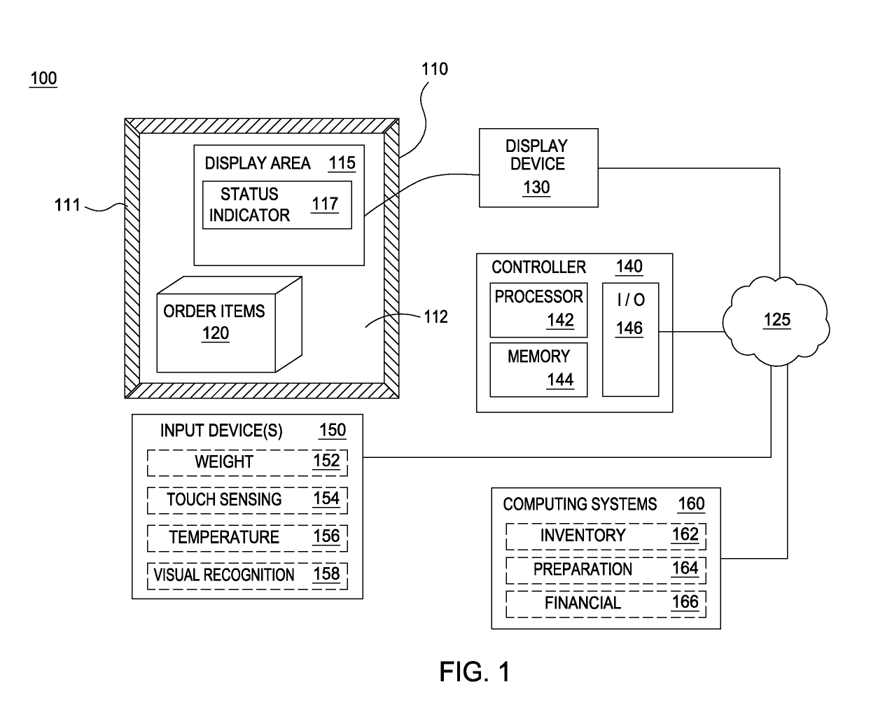

FIG. 1 depicts an interactive order fulfillment system, according to one embodiment described herein. Interactive order fulfillment system 100 includes one or more receptacles 110, a display device 130, a controller 140, and one or more input devices 150. Receptacle 110 (shown here in a top-down perspective) includes at least one surface, such as a bottom surface 112 or one or more walls 111. Some non-limiting examples of receptacle 110 include boxes, containers, trays, buckets, crates, or any other device suitable for containing and/or transporting other items. Of course, depending on size and configuration, any surface of receptacle 110 may be suitable for displaying order fulfillment status consistent with descriptions provided herein. For simplicity, receptacle 110 is shown as containing one or more order items 120; of course, receptacle 110 need not always contain order items (i.e., the receptacle may be empty), and may further contain other, non-order items. Each of the order items 120 may vary in shape, size, weight, etc.

Controller 140 includes one or more processors 142, memory 144, and input/output (I/O) 146. Processor 142 is generally configured to read and execute code stored in memory 144, and to communicate with various peripheral devices and/or other computing systems through I/O 146. Memory 144 may include both volatile memory, such as various types of random access memory (RAM), as well as one or more forms of non-volatile memory (e.g., hard drives, solid state drives, Flash memory, etc.). Importantly, controller 140 may maintain data related to order fulfillment status within memory 144. As shown, the controller I/O 146 is connected through network 125 to display device 130, input devices 150, and computing systems 160. Network 125 may represent multiple types of physical and logical connections; for example, display device 130 and input devices 150 may be directly coupled to controller 140 via video and other cabling (as in an ordinary personal computer configuration), while controller 140 is communicatively coupled to other computing systems 160 through a local access network (LAN) or wide area network (WAN), whether through a wired or wireless connection.

The display device 130 may include any device capable of displaying onto one or more surfaces of a receptacle in a manner consistent with the descriptions provided herein. Display device 130 may be configured to display in display area 115 onto at least a portion of the surface. The display area may have a fixed size and position, but as will be described more fully below, certain embodiments may allow the display area to be dynamically moved on the surface, or even onto different surfaces. Within display area 115, the display device 130 may also display one or more order fulfillment status indicators 117, as are described briefly above and will be further described below. In one embodiment, the display device may be a projector configured to project onto a surface of receptacle 110. Another embodiment may provide display device 130 as a liquid crystal display (LCD) or other display technology integrally formed in the receptacle, such as an LCD embedded in a surface of a reusable tray.

Input devices 150 may include one or more different types of sensors or devices capable of detecting input at or proximate to receptacle surfaces. Input devices 150 may include one or more of weight sensors 152, touch sensing devices 154, temperature sensors 156, and visual recognition devices 158. Of course, other input devices may be alternately or additionally employed, such as sensors or devices configured to read coding on order items (e.g., serial barcodes or Quick Response (QR) codes), sensors or devices configured to electrically couple with elements of the order items (e.g., radio-frequency identification (RFID) tags included with the order items and readers included in or near receptacles), and so forth.

Weight sensors 152 may include strain gages or piezoelectric elements disposed within or adjacent to the receptacle 110 and that are capable of measuring weight of the one or more order items 120 as they are placed into the receptacle. Multiple weight sensors 152 may be disposed in an arrangement along a particular receptacle surface in order to sense weight distribution with a greater resolution, which in turn may improve the identification of order items 120.

Touch sensing devices 154 may include touch sensors, such as resistive, inductive or capacitive touch sensors (or using any other touch sensing technology); in certain embodiments, the touch sensing devices may be integrally formed in a surface of the receptacle. The touch sensing devices are generally selected to be compatible with the display device 130; for example, the LCD disclosed above may include a transparent surface with an array of touch sensors, or the array of touch sensors may be included in a surface of the receptacle while a projector displays onto the surface (or another surface).

In an alternate embodiment, touch sensing devices 154 may include a depth camera used to determine relative distances between detected objects and a surface of the receptacle. By using a depth camera, an ordinary surface may be interactively used by an individual. In determining the relative distances, the system may be able to positively identify the detected objects. The detected objects may include the one or more order items 120, and may also include manual input from a user (i.e., touch with one or more fingers). Calibration and the distance determinations may be performed by computing logic included with the depth camera, or may be performed by processor 142 as data is received at controller 140.

Temperature sensors 156 may also be included for item identification, and may further provide quality control for the order fulfillment. For example, certain order items may be heated to different temperatures before order fulfillment (e.g., food service) or may be stored at different temperatures. Additionally, to ensure customer satisfaction, the temperature sensors may be used during the order fulfillment process (for example, just prior to completion of the order fulfillment, at which point a customer may receive their food). The temperature sensors 156 may be able to identify items by an absolute or relative temperature value, or a spatial temperature distribution (which is related to item size, another identifying feature for items). The temperature sensors 156 may include thermocouples, thermistors, or resistance temperature detectors (RTDs), which are preferably located proximate to the receptacle to more accurately detect temperature of any items contained therein. Alternately, the temperature sensors 156 may include an infrared (IR) sensor configured to detect heat emitted by items contained within the receptacle; this may include IR sensors proximate to the receptacle, or perhaps an IR camera at some distance from the receptacle. In one embodiment, an IR camera may be disposed adjacent to a projector that displays onto a receptacle surface, and the IR camera and projector may be included in a common housing.

Visual recognition devices 158 may also be included for item identification, according to any feasible techniques familiar to a person of ordinary skill in the art. In one non-limiting example, an ordinary camera or charge-coupled device (CCD) sensor may be included to capture images of the surface, and the processor 142 may perform image processing on the captured images to determine whether one or more items have been placed onto the surface, and to identify the placed items. In one embodiment, the processor 142 may perform visual recognition using artificial neural networks implemented in hardware, or included in software stored on memory 144.

Controller 140 may also be connected through network 125 to one or more computing systems 160, which may perform certain ancillary functions related to order fulfillment such as inventory management 162, item assembly, production, or preparation 164, financial functions 166, etc. Alternately, some or all of these functions may be performed by controller 140. Output data from various functions of the computing systems 160 may be provided to controller 140, which using processor 142 may perform computation or other processing on the data, and may update any order fulfillment status calculations (such as an estimated time to fulfillment for various items).

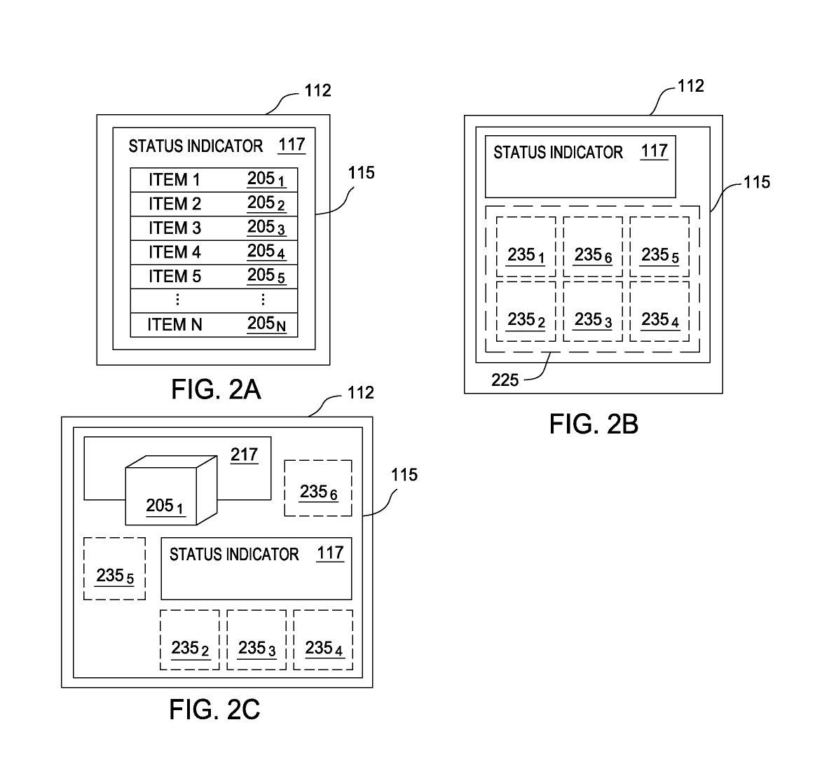

FIG. 2A depicts an interactive surface in an interactive order fulfillment system, according to one embodiment described herein. The interactive surface 112 may generally be included as part of fulfillment system 100. Display area 115 is included within the area of surface 112, and within display area 115 are one or more status indicators 117. For simplicity of description, the indicators 117 are depicted here as a textual listing of order items 205₁-205_{N}, and at an initial size and position within display area 115; of course, the indicators 117 may be displayed in alternate textual or graphical formats (or in combinations thereof) generally as described above.

Beyond merely indicating order fulfillment status, in certain embodiments the interactive order fulfillment system may also provide a prescribed placement within the receptacle (or between different receptacles) for those order items that have not yet been fulfilled. The interactive order fulfillment system may display placement locations for these unfulfilled items onto the receptacle surface using text or simple graphics; for example, a text box containing the name of the particular item. In certain embodiments, the system may display detailed (e.g., photographic) representations of the items onto the receptacle surface, so that the surface appears similar to how it will appear when the order is entirely fulfilled according to the prescribed placement. Providing these detailed representations may increase accuracy and efficiency of the order fulfillment, especially where one or more individuals are manually fulfilling the order. The visual representations may be quickly interpreted and understood by the individual(s) fulfilling the order, even in a stressful or fast-paced environment, and may reduce any need for consideration of item placement or for communication and coordination between individual(s). Further, any incorrect placement of an item may be quickly identified and corrected. For example, the system may display photos of a book having a red cover onto a portion of a box surface, and another book having a black cover onto another portion of the surface; using the displayed photos and their placement, two employees may simultaneously work to fulfill the order (say, each employee retrieves one book and places their respective book onto the matching display portion) without unnecessary consideration or coordination.

The interactive order fulfillment system may determine its prescribed placements based on any number of different factors, such as maximizing the available area or volume of the receptacle, meeting certain weight thresholds (e.g., minimum and/or maximum weights) for items in the receptacle, optimizing a weight distribution of items within the receptacle, protecting less durable items, etc. For example, for a fast food order including a hamburger, French fries, and soft drink, the system may prescribe that the (presumably) heavier soft drink be placed towards the center of the tray, thereby reducing instability as the tray is carried by a customer. The system may also distribute order items to be fulfilled using multiple receptacles based on size or weight of the items, as well as the size or weight capacity of the receptacle; of course, this may include distribute items across different types of receptacles (i.e., having different sizes or strength ratings). For example, certain order items (or combinations of items) might be too heavy or dense so that the items are not suitable to be placed in a standard cardboard packaging box, but could instead be placed in a plastic crate having greater strength.

As order items are fulfilled, the interactive order fulfillment system may update its display accordingly. For example, order items which have already been correctly fulfilled (i.e., correct items and placed according to prescribed placement locations) may no longer require the location to be displayed at the receptacle surface. Further, any items that are incorrectly fulfilled (e.g., an incorrect item, an incorrect placement, an incorrect weight for the item, etc.) may affect the factors considered in determining the prescribed placements, so that the system may be required to update placement locations for the remaining unfulfilled items.

In response to any type of incorrect fulfillment, the system may provide an alert using the display, and may maintain the alert until the error is acknowledged or corrected. Alternatively, in the case of a correct item that was incorrectly placed (or that perhaps shifted after placement), the system may adaptively update its placement locations, determining new placement locations for one or more unfulfilled items based on the properties of the item incorrectly placed.

In some embodiments, the system may weigh items as each is placed in the receptacle, providing an alert indicating that the item's determined weight does not equal (or falls outside some range of) an expected weight for the item. The expected weight values (against which the determined weights are compared) generally may be stored in a memory of the interactive order fulfillment system, or accessed from a networked computing system. In other embodiments, items are selectively weighed according to any number of criteria; one criterion for weighing items may be whether additional employee actions are necessary for the item's fulfillment. For example, a soft drink cup may have an expected weight that is based on the volume of liquid added, which is expected to be added by an employee. Weight checking may thus provide an additional quality control measure to the fulfillment process.

FIGS. 2B and 2C depict an interactive surface in an interactive order fulfillment system, according to one embodiment described herein. The interactive surface 112 may generally be included as part of fulfillment system 100. Beyond including status indicators 117, the display area 115 includes an item placement area 225. While shown as one contiguous area for simplicity, the item placement area 225 may be divided into multiple distinct areas and dispersed across the display area 115. Within item placement area 225, the prescribed placements 235₁-235₆ are disposed. In this example, the order items 205 included in the status indicator 117 (order items 205₁-205_{N}, as shown in FIG. 2A) each correspond to a different prescribed placement. Assume for purposes of this example that order item 205₁ corresponds to prescribed placement 235₁, 205₂ to 235₂, and so forth.

The prescribed placements 235 may be determined according to any of the different factors described above. For example, assume that interactive surface 112 is a tray having relatively short side walls and that items placed onto the tray may fall off (or tip over, etc.) during subsequent movement of the tray. The interactive order fulfillment system 100, using its controller 140, may determine (based on properties of order items to be fulfilled, and properties of the tray itself) that the total weight of items 205₁-205₆ corresponding to placements 235₁-235₆ is within a maximum weight threshold for the tray (i.e., the tray will be able to support the total weight), and that heavier items should be placed nearer to the center of the surface in order to prevent unnecessary imbalance of the tray. The interactive order fulfillment system 100 may also include preferences for display of the status indicators 117, such preferences being included either in the software in memory 144, or received as an input to the controller 140. Assume here that a preference has been specified for display in one contiguous area and adjacent to item placement area 225. The controller 140 may the determine the layout of prescribed placements 235 and status indicators 117 that are depicted in FIG. 2B, based on the weights of the order items to be fulfilled, the properties of the receptacle (i.e., the tray), and the display preferences.

In FIG. 2C, and continuing the example, a first order item 205₁ has been placed onto the interactive surface 112. However, instead of being placed at the location of prescribed placement 235₁, item 205₁ was placed at a location that overlapped the displayed status indicator (former position 217). The interactive order fulfillment system 100 in some embodiments may be configured to produce an alert in response to such an incorrect fulfillment; however, for purposes of this example, assume that the interactive order fulfillment system 100 is configured to adaptively update placement of the remaining unfulfilled items based on the incorrectly placed item (i.e., its weight and location). Considering also the earlier specified preference for one contiguous display area for status indicators 117, the controller 140 may then determine the layout of prescribed placements 235 and status indicators 117 as shown in FIG. 2C, and may move these display elements accordingly. This item fulfillment process may generally repeat as additional items are placed onto the interactive surface 112, ending when the order has been fulfilled (i.e., when all order items 205 included on the interactive surface 112). The item fulfillment process may also end upon certain events, such as determining an inability to meet all the parameters for prescribed placements. For example, the incorrect placement of order item 205₁ may have created a condition in which determining an acceptable weight distribution (i.e., within receptacle ratings and/or an estimate of imbalance) was impossible. Of course, this is meant to be only one non-limiting example; other configurations consistent with the above description are possible, such as distributing order items and displaying status indicators across multiple receptacles, identifying and selecting receptacles of different types for order fulfillment, overriding preferences, weighted determinations, and so forth.

The interactive order fulfillment system may update the order fulfillment status as order items are fulfilled, and may in turn display the updated order fulfillment status. Typically, order items are fulfilled by placing the items into the receptacle. In some embodiments, the interactive order fulfillment system may automatically detect when items have been placed into the receptacle, such as by using weight measurements, visual recognition, temperature characteristics, etc. As described above, various input devices 150 may be used to accomplish detection of the order items, and may include weight sensors, touch sensing devices, temperature sensors, visual recognition devices, as well as other devices known in the art for performing detection. Additionally or alternatively, an individual fulfilling the order may manually indicate that certain items have been fulfilled, for example by entering input through a user interface. The interactive order fulfillment system may also receive user inputs through touch sensing devices, such as discrete touch sensors or with a depth camera configuration, essentially as described above.

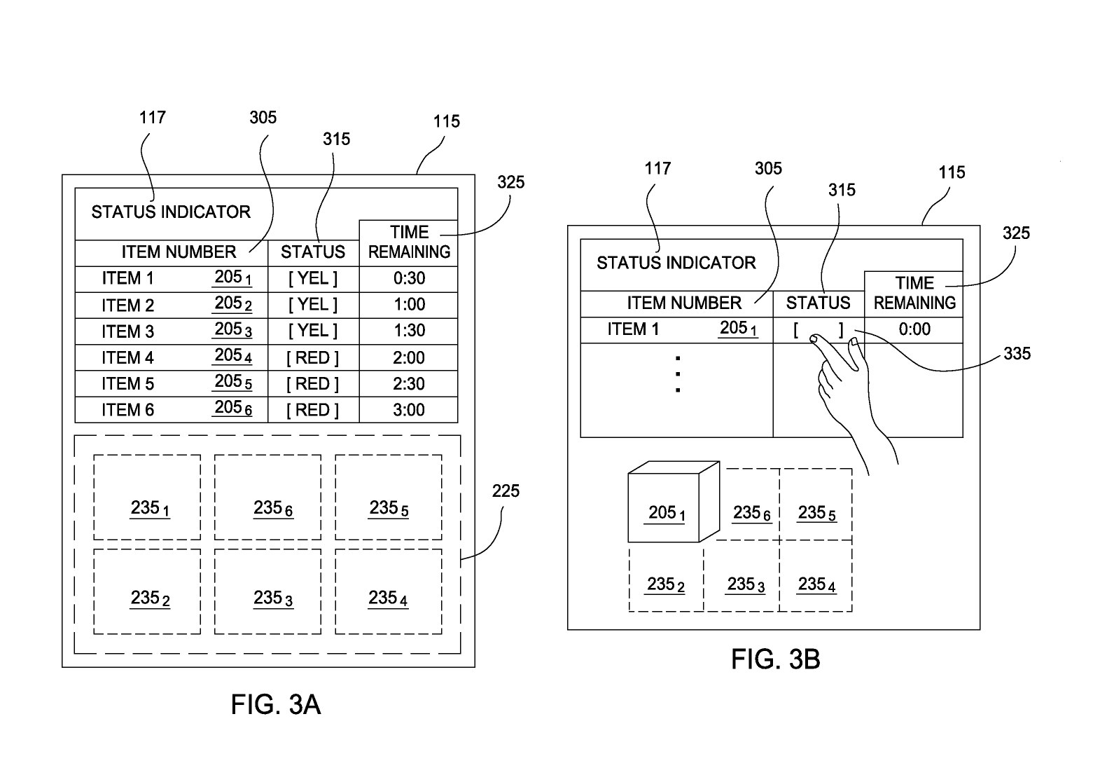

FIGS. 3A and 3B depict a display area in an interactive order fulfillment system, according to one embodiment described herein. The display area 115 may generally be included on an interactive surface 112 as a part of fulfillment system 100. In this embodiment, status indicators 117 include a textual listing of order items by item number 305, a fulfillment status 315, and a time remaining 325. Of course, the order fulfillment status may be displayed using different data or in any alternate textual or graphical manner, consistent with the descriptions provided above. For example, the status indicators may include a fulfillment status or time remaining for the entire order, in addition to the item-level data provided in FIG. 3A. As shown, the fulfillment status 315 for each item is color-coded based on the estimate of time remaining 325. Using the red-yellow-green color scheme described earlier, fulfilled items correspond to a fulfillment status value of green ([GRN]), items with remaining times equal to or less than one minute and 30 seconds (1:30) correspond to a fulfillment status value of yellow ([YEL]), and for remaining times exceeding 1:30, the fulfillment status value is red ([RED]). Of course, any color scheme or various times or other criteria may be selected to indicate fulfillment status.

In FIG. 3B, and continuing the example, a first order item 205₁ has been placed onto the interactive surface 112 at its prescribed placement 235₁. Depending on the input devices used for item detection in the particular embodiment, interactive order fulfillment system may automatically detect the (correct) placement of the order item 205₁ and automatically update the status indicator using controller 140. For example, the fulfillment status 315 corresponding to the item may be changed to [GRN], and the time remaining 325 may be deleted or a zero value; in some embodiments, the listing corresponding to the fulfilled item 205₁ may be removed entirely from the status indicator. Alternatively, a user may manually interact with the interactive surface (perhaps by touching the surface at the location 335 the fulfillment status field is displayed), and select the updated [GRN] color or otherwise indicate that the item has been fulfilled.

In some embodiments, the interactive order fulfillment system may support simultaneous, separate interactions on the receptacle surface. In certain contexts (e.g., fast food or retail service), the receptacle may be located on a counter between the employee(s) fulfilling the order, and the customer awaiting receipt of the order. While the order is being fulfilled, the customer may interact with a separate display interface on the receptacle, whether for entertainment (e.g., displaying interactive games or videos) or to modify their placed order. For example, a fast food customer while waiting may realize that she forgot to order extra pickles on her hamburger, and perhaps decides to change the size of the soft drink in her order. The customer, by interacting with the separate display interface during order fulfillment, may add or remove items, or modify items from the placed order, and if necessary pay any difference in price. One or more display devices may be used to project the separate display interface onto the surface. In one embodiment, both the order fulfillment interface and the customer interface are displayed using one display device, which may orient each interface to its intended user (e.g., the order fulfillment interface oriented for viewing by employee(s) fulfilling the order, and the customer interface oriented for viewing by the customer.

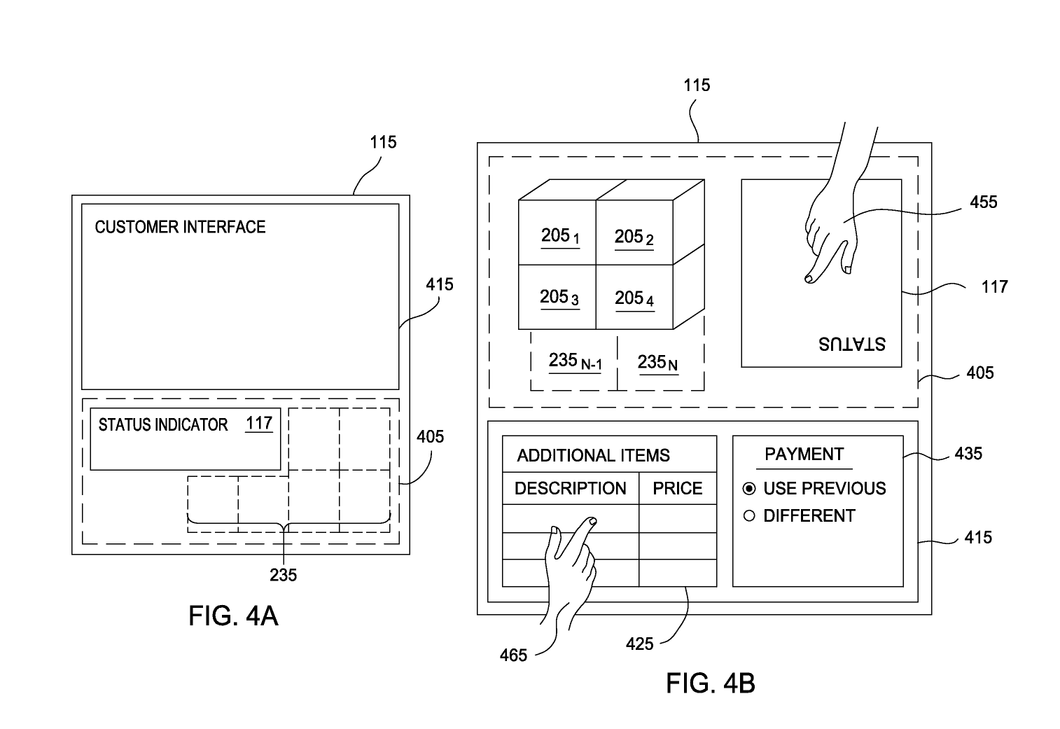

FIGS. 4A and 4B depict a display area in an interactive order fulfillment system, according to one embodiment described herein. The display area 115 may generally be included on an interactive surface 112 as a part of fulfillment system 100. An order fulfillment interface 405 and a customer interface 415 are shown. The order fulfillment interface 405 may include status indicators 117 and prescribed placements 235, and may operate the same or substantially similarly to the embodiments depicted in FIGS. 1-3B and as described above. Each interface may be displayed onto the interactive surface (or alternately, onto separate surfaces) using separate display devices 130, or each may be displayed using a single display device 130. The interfaces may be displayed with different orientations, such as with a 180° shift. While each interface is shown as being contiguous, and as being comparable in size and adjacent to one another on the interactive surface, the interfaces 405, 415 may vary in size, distribution, relative positioning, and so forth.

FIG. 4B further depicts a simultaneous interaction with the interfaces 405, 415 during order fulfillment. As shown, several order items 205₁-205₄ have been placed onto the surface of the receptacle, and the items corresponding to prescribed placements 235_{N-1} and 235_{N} have yet to be fulfilled. Though perhaps not immediately apparent, the order fulfillment interface 405 is oriented at an employee 455 and at an approximately 180° shift from customer interface 415, so that the status indicators 117 may be easily read and understood by located on one side of the receptacle and who may be fulfilling the order. Customer interface 415 is oriented toward a customer 465 and may include, for example, a menu 425 of additional items for addition and/or purchase, as well as a payment menu 435. In some embodiments, the payment menu 435 may be configured to receive the customer's payment while allowing employees to continue fulfilling the order, that is, without requiring the employee to complete another cash register transaction. Accordingly, payment selections in the payment menu 435 may include using a previous payment method, such as a credit or debit card or electronic account that was used to complete the initial order transaction, or using a new payment method (e.g., a different card). Other embodiments may provide menu options for alternate forms of payment (such as cash, checks, etc.). After payment, changes to the order made by the customer 465 may be reflected in the status indicators 117, such as by adding entries for newly ordered items, etc.

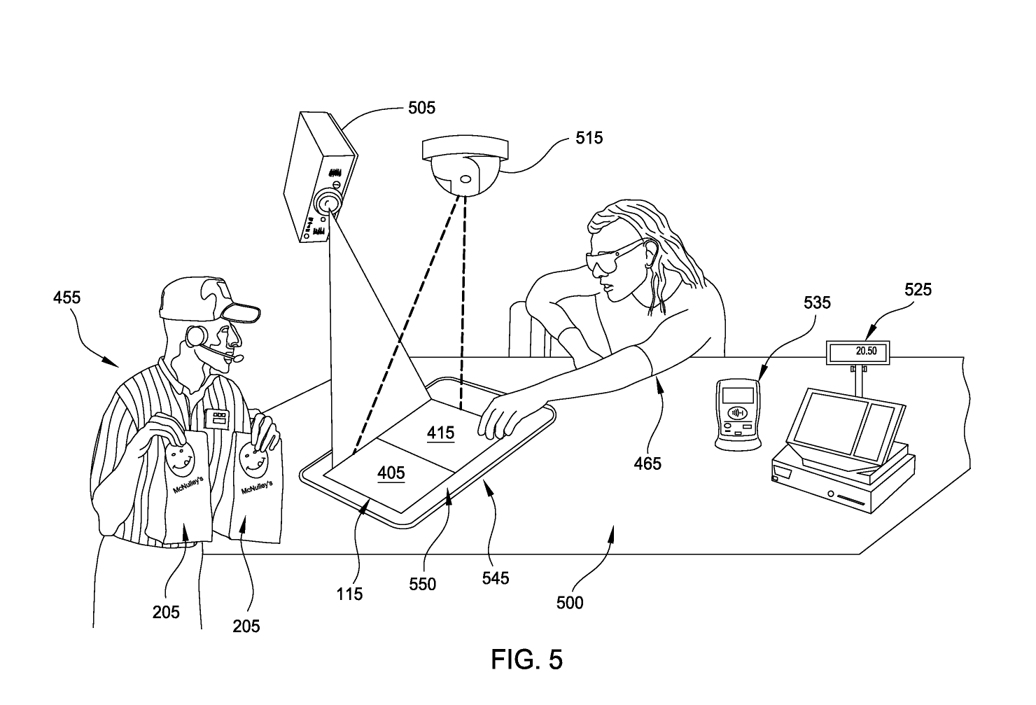

FIG. 5 depicts an example of an interactive order fulfillment system, according to one embodiment described herein. A retail counter 500 generally separates employee-only areas from those accessible by customers. The counter 500 includes a cash register 525 and a near field communication (NFC) reader 535, which may be coupled to the cash register 525 and is typically used to receive contactless payments. The cash register 525 and NFC reader 535 are examples of computing system(s) 160 networked to the interactive order fulfillment system 100. After completing an order transaction, a tray 545 (an example of receptacle 110) may be placed onto the counter 500 and the order fulfillment status displayed onto a surface 550. A projector 505 (an example of display device 130) may display the order fulfillment interface 405, as well as a separate customer interface 415, onto a display area 115 comprising at least part of the surface 550. The interfaces may be oriented differently and towards their intended users; order fulfillment interface 405 may be oriented to employee 455, who is on one side of counter 500, and customer interface 415 towards customer 465 on the other side of the counter 500. A depth camera 515 (example of touch sensing device 154) may be configured to detect input at or near the display area 115, such as touch input from customer 465 or employee 455, or from fulfilled order items 205 placed into the tray 545. During the order fulfillment process, customer 465 may select additional items for purchase, which updates the order and the order fulfillment status indicators accordingly.

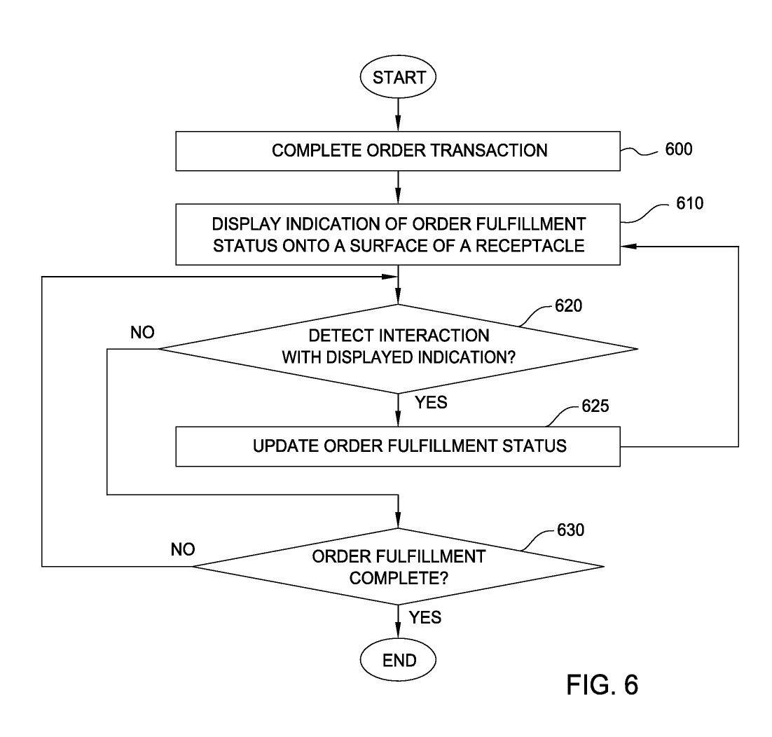

FIG. 6 is a block diagram depicting a method for order fulfillment, according to one embodiment described herein. The method may generally be used by elements of interactive order fulfillment system 100, and may include features of the various embodiments disclosed in FIGS. 1-5 and described above.

The method begins at block 600, where an order transaction is completed. Consistent with examples above, completing the transaction may include selection and payment for items of an initial order. This initial order may later be modified during the fulfillment process, as items are added, removed, or altered by a customer, or are fulfilled by employee(s).

At block 610, an indication of order fulfillment status is displayed onto a surface of a receptacle. This may include textual and/or graphical status indicators for items included in the order, groups of items, and/or for the entire order itself.

At block 620, the interactive order fulfillment system determines whether an interaction with the displayed indication has been detected by one or more input devices. This may include manual (i.e., touch) input from a customer or employee, or may be in response to detecting and identifying order items placed into the receptacle.

If an interaction is detected, the method proceeds to block 625, where the interactive order fulfillment system 100 updates the order fulfillment status(es) based on the detected interaction. This may include updates as items from the order are fulfilled, as well as if a customer modifies the initial order during the fulfillment process. The method returns to block 610, where the updated order fulfillment status is displayed.

However, if an interaction is not detected at block 620, the method instead proceeds to block 630, where the interactive order fulfillment system determines whether the order has been completely fulfilled. If the order has remaining unfulfilled items, the method may continue to loop between blocks 620 and 630 until an interaction is detected. Alternately, block 620 may return to itself if no interaction is detected, acting essentially as a wait state. If the order has been completely fulfilled at block 630, the method may end.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, the interactive order fulfillment system may access applications or separate computing systems related to the order fulfillment process (e.g., inventory management, item assembly or preparation, transportation, etc.) or related data available in the cloud. For example, an inventory management application could execute on a computing system in the cloud and provide inventory-related data to the interactive order fulfillment system in order to generate more accurate estimates of order fulfillment status and projected completion. In such a case, the inventory management application could monitor stock quantities at several dispersed warehousing locations and store the data at a storage location in the cloud. Doing so generally allows any computing system that is attached to a network connected to the cloud (e.g., the Internet) to access this data.

While the foregoing is directed to embodiments of the present invention, other and further embodiments of the invention may be devised without departing from the basic scope thereof, and the scope thereof is determined by the claims that follow.

What is claimed is:

1. A method, comprising:
displaying an indication of an order fulfillment status onto a surface of a receptacle, the receptacle configured to receive one or more items included in the order; and
based on a detected interaction with the displayed indication, updating the order fulfillment status.

2. The method of claim 1, wherein the indication is displayed onto the surface using a projector.

3. The method of claim 1, wherein the detected interaction comprises one or more of detecting an item placed into the receptacle, and manually indicating a change to the order fulfillment status.

4. The method of claim 1, wherein displaying the indication further comprises indicating one or more locations within the receptacle for placing a corresponding one or more unfulfilled items from the order.

5. The method of claim 4, further comprising adaptively updating the indicated one or more locations, based on the detected interaction.

6. The method of claim 1, wherein the interaction is detected using one or more of a camera configured to distinguish items placed into the receptacle, a depth camera configured to detect touches at the surface of the receptacle, and a weighing device configured to weigh the receptacle and one or more items placed therein.

7. The method of claim 1, wherein the indication includes one or more of a list including at least one unfulfilled item from the order, a color-coded indication of the order fulfillment status, and an estimated time until fulfillment of the order.

8. The method of claim 1, wherein displaying the indication onto the surface occurs with a first orientation, and further comprising displaying a customer interface onto the surface with a second orientation.

9. The method of claim 8, further comprising updating the order based on an interaction with the customer interface.

10. An interactive order fulfillment system, comprising:
a receptacle for receiving one or more items from the order;
a display device configured to display an indication of an order fulfillment status onto a surface of the receptacle;
an input device configured to detect interaction with the displayed indication; and
a controller configured to, based on the detected interaction, update the order fulfillment status.

11. The interactive order fulfillment system of claim 10, wherein the display device comprises a projector.

12. The interactive order fulfillment system of claim 10, wherein the detected interaction comprises one or more of detecting an item placed into the receptacle, and manually indicating a change to the order fulfillment status.

13. The interactive order fulfillment system of claim 10, wherein the display device is further configured to indicate one or more locations within the receptacle for placing a corresponding one or more unfulfilled items from the order.

14. The interactive order fulfillment system of claim 13, wherein the display device is further configured to adaptively update the indicated one or more locations, based on the detected interaction.

15. The interactive order fulfillment system of claim 10, wherein the input device comprises one or more of a camera configured to distinguish items placed in the receptacle, a depth camera configured to detect touches at the surface of the receptacle, and a weighing device configured to weigh the receptacle and one or more items placed therein.

16. The interactive order fulfillment system of claim 10, wherein the indication includes one or more of a list including at least one unfulfilled item from the order, a color-coded indication of the order fulfillment status, and an estimated time until fulfillment of the order.

17. The interactive order fulfillment system of claim 10, wherein the display device is configured to display the indication onto the surface with a first orientation, and is further configured to display a customer interface onto the surface with a second orientation.

18. The interactive order fulfillment system of claim 17, wherein the controller is further configured to update the order based on an interaction with the customer interface.

19. A computer-readable storage medium storing an application, which, when executed on a processor, performs an operation, comprising:
displaying an indication of an order fulfillment status onto a surface of a receptacle, the receptacle configured to receive one or more items included in the order; and
based on a detected interaction with the displayed indication, updating the order fulfillment status.

20. The computer-readable storage medium of claim 19, wherein displaying the indication onto the surface occurs with a first orientation, and further comprising displaying a customer interface onto the surface with a second orientation.
